(19) United States
(12) Patent Application Publication
(10) Pub. No.: US 2007/0291762 A1
(43) Pub. Date: Dec. 20, 2007

(54) PATH ROUTE CALCULATION APPARATUS, METHOD AND PROGRAM

(75) Inventor: Hiroshi YOKOTA, Yokohama-shi (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 11/775,312

(22) Filed: Jul. 10, 2007

Related U.S. Application Data
(63) Continuation of application No. PCT/JP2005/001106, filed on Jan. 27, 2005.

(51) Int. Cl. H04L 12/56

(52) U.S. Cl. 370/395.3

(57) ABSTRACT

A path route calculation apparatus for obtaining a route of ports of a path in a communication network configured by connecting a plurality of transmission apparatuses by links with each other is disclosed. The path apparatus includes: a condition receiving unit configured to receive a condition including identification information of transmission apparatuses existing on the path and a signal level of the path; a table generation unit configured to generate a table, for each of transmission apparatuses on the path, that includes identifiers of each port corresponding to the signal level and flags indicating use status of each port; a path route determination unit configured to determine the route of ports of the path by performing logical operation for values of the flags in tables generated by the table generation unit.

### CROSS-REFERENCE TO RELATED APPLICATION

This application is a U.S. continuation application filed under 35 USC 111(a) claiming benefit under 35 USC 120 and 365(c) of PCT application PCT/JP2005/001106, filed on Jan. 27, 2005, the entire contents of which are hereby incorporated by reference.

### TECHNICAL FIELD

The present invention relates to a technique for route search of a path in a communication network configured by connecting a plurality of transmission apparatuses with each other.

### BACKGROUND ART

A path network is formed by connecting transmission apparatuses that have a cross-connect function using physical lines. The network including the transmission apparatus (to be also referred to as NE: Network Element) is managed by using an EMS (Element Management System) and an NMS (Network Management System) as shown in FIG. 1A. By the way, the network managed by the EMS and the NMS generally takes a ring configuration or a linear configuration as shown in FIG. 1B.

In the example of FIG. 1A, each EMS monitors a plurality of transmission apparatuses, and one NMS monitors a plurality of EMSes. Each EMS has a database including apparatus configuration, cross-connect information and information of path use status in a unit and the like for each transmission apparatus under the EMS. In addition, operation for the NMS, EMS and the transmission apparatuses is performed via a client terminal.

For establishing a path for a desired signal level in a section of a communication network including a plurality of transmission apparatuses connected via physical lines (also to be referred to as links), it is necessary to determine interfaces used in each transmission apparatus first. To determine the interfaces is called path route search. In the following, the path route search method is described.

FIG. 2 shows an example of an apparatus layout in one shelf of a transmission apparatus. In the example shown in FIG. 2, transmission line interface units (transmission line interface unit is simply referred to as “unit” hereinafter) are implemented in slot numbers 1-20. As types of the units, there are ten types that are STM64S, STM16S, STM4Q, STM1Q, STM1D, STM1E, E12, LANGP1, LANFP1 and LANGX1, for example. In addition, available slot numbers and AID assigning rule are determined for each unit. “AID” is an identifier for identifying assignment of a path in each signal level in each unit. Hereinafter, AID is also called as an assignment identifier. By the way, apparatus layout/unit type is different for each target transmission apparatus, and apparatus layout/unit type described in the present specification is an example.

FIG. 3 shows available signal levels and assigning rules for assignment identifiers for each of unit types (STM64S, STM16S, STM4Q, STM1Q, STM1D, STM1E and E12). For example, it can be found that the unit of STM16S can establish a link connection of bandwidth of 2.4G, and that the unit can be implemented in slot numbers 3-10 and 13-20. By the way, FIG. 3 does not show LANGP1, LANFP1 and LANGX1. In addition, the unit of STM16S can have four types of path signal levels that are VC416C, VC44C, VC4 and VC12. By the way, the path signal levels VC416C, VC44C, VC4 and VC12 have bandwidths of 2.4G, 600M, 150M and 2M respectively. According to the assigning rule shown in FIG. 3, assignment identifiers for each signal level are as shown in FIG. 4 when the unit of STM16S is implemented in a slot 19.

Input/output interfaces of a path of each signal level can be obtained by logically dividing a maximum bandwidth that can be used in the unit. For example, since a maximum bandwidth between transmission apparatuses that are connected by using the STM16S unit is 2.4G, one path of the VC416 level can be set, four paths of VC44C can be set, 16 paths of VC4 can be set, and 1008 paths of VC12 can be set. By the way, the input/output interface of a path in a transmission apparatus obtained by logically dividing the maximum bandwidth is called as “port” in this specification. This “port” is logical one.

In the following, a conventional path route search process that is executed by the NMS is described. As an example, a route search for a VC4 path from an input side port: 5-1-1 of an apparatus 1 to an output side port: 5-1-1-7 of an apparatus 3 is described in a network configuration in which transmission apparatuses 1-4 are connected via physical links #1-#4 as shown in FIG. 5.

In the following, the path route search process is described with reference to FIG. 7 along with a flowchart shown in FIG. 6.

First, in step 1, an operator of the NMS designates from a client terminal a start point: 5-1-1, an end point: 5-1-7, a route: transmission apparatus 1->transmission apparatus 2->transmission apparatus 3, and a signal level: VC4. In step 2, the NMS searches a database of cross-connect information in the EMS that manages the transmission apparatuses 1-3 for an output side port, in the transmission apparatus 1, that can connect to the start point: 5-1-1 by cross-connection. In this example, the NMS searches for an output side port of a signal level the same as that of the start point that can be used in the transmission apparatus 1.

More particularly, as shown in FIG. 7, an output side port: 19-1-1 of VC4 is selected from four candidates.

In step 3, the NMS searches the database of the EMS to follow link connection toward the opposed transmission apparatus 2 that is physically connected to the output side port: 19-1-1, and determine an input side port: 20-1-1 of the transmission apparatus 2 corresponding to the output side port: 19-1-1 of the transmission apparatus 1. By the way, if the input side port: 20-1-1 of the transmission apparatus 2 is not available (if NG in step 4), steps 2 and 3 are executed again.

The process of steps 2-4 is performed for each transmission apparatus. Therefore, the NMS selects an output side port 19-1-1 from four VC4 output side ports that can be connected to the input side port: 20-1-1 in the transmission apparatus 2. In addition, the NMS follows link connection between the transmission apparatus 2 and the transmission apparatus 3 using the database of the EMS so as to determine an input side port 20-1-1 of the transmission apparatus 3 that is connected to the output side port: 19-1-1 of the transmission apparatus 2. Then, if the input side port: 20-1-1 of the transmission apparatus 3 can be connected to the end point: 5-1-7, the path route search ends.

According to the above-mentioned processes, a route of ports of the path is determined to be 5 -1-1->19-1-1->20-1-1->19-1-1->5-1-1-7 (step 5). The NMS sends the determined information of ports of the path to the EMS, and the EMS updates the database to register the path (step 6).

By the way, there is a technique described in the following Patent Document 1, for example, as a conventional technique related to the path route search.

[Patent document 1] Japanese Laid-Open Patent application No. 9-135243

### DISCLOSURE OF THE INVENTION

### Problem to be Solved by the Invention

The conventional path route search method has a problem that there is a case where search process is repeated so that process time increases according to port use status. In the following, this problem is described using two examples.

First, a case for performing route search for a path that is a BLSR (Bidirectional Line Switched Ring) setting target is described with reference to FIG. 8. By the way, BLSR is a function in a ring configuration for switching an active path to a maintenance path when a failure occurs in the active path.

In this example, as to each path that is a BLSR setting target, it is necessary that the last number (indicating AID channel) of the assignment identifier is the same for all ports though which the path passes. Like the case of FIG. 7, it is assumed that condition for searching is start point: 5-1-1, end point: 5-1-7, route: transmission apparatus 1->transmission apparatus 2->transmission apparatus 3, and signal level: VC4. In addition, in this example, it is assumed that an output side port: 19-1-1 of the transmission apparatus 2 and an input side port: 20-1-1 are in use for other path.

Under this condition, the output port 19-1-1 that is available in the transmission apparatus 1 is selected from the start point: 5-1-1 (step 11). By following link connection from the output port: 19-1-1 of the transmission apparatus 1, the input side port: 20-1-1 of the transmission apparatus 2 is selected (step 12). In the transmission apparatus 2, as an output side port that is connected to the input side port: 20-1-1, 19-1-1 that has a last number the same as that of the assignment identifier 20-1-1 becomes the only candidate. However, since 19-1-1 is being used, there is no other alternative, so that search for an output side port is performed in the transmission apparatus 1 again.

In this time, an output side port: 19-1-4 of the transmission apparatus 1 is selected (step 13), and an input side port: 20-1-4 of the transmission apparatus 2 opposed to the output port is selected (step 14). In the transmission apparatus 2, an output side port: 19-1-4 that is connected to the input side port: 20-1-4 is selected (step 15), and an input side port: 20-1-4 of the transmission apparatus 3 is selected (step 16). If this input side port: 20-1-4 is connectable to the end point: 5-1-7, the path route search ends, so that a path that passes through the selected ports on the route is registered. In the above-mentioned example, failure of search process occurs in the transmission apparatus 2, and repeated search occurs.

A case where the search target path is not a target for BLSR is described with reference to FIG. 9. In this example, it is assumed that the input side port: 20-1-1 and the output side port 19-1-1 in the transmission apparatus 2 are in use. Other conditions are the same as those of the example described with reference to FIG. 7.

The output side port of the transmission apparatus 1 is selected from the start point 5-1-1 (step 21), and an input side port: 20-1-1 of the transmission apparatus 2 that is connected to the output side port is selected (step 22). However, since the input side port: 20-1-1 of the transmission apparatus 2 is in use, output port selection is performed again in the transmission apparatus 1. At this time, an output side port 19-1-4 of the transmission apparatus 1 is selected (step 23). Then, an input side port: 20-1-4 of the transmission apparatus 2 connected to the port is selected (step 24), the output side port: 19-1-4 of the transmission apparatus 2 is selected (step 25), and the input side port: 20-1-4 of the transmission apparatus 3 is selected (step 26). When the input side port: 20-1-4 is connectable to the end point 5-1-7, the path route search ends, so that a path passing through the selected ports on the route is registered. Also in the above-mentioned example, failure of the search process occurs in the transmission apparatus 2, and repeated search occurs. When such repeated search is performed, search process time increases and time required for path registration increases.

In addition, in the conventional path route search process, a path route is determined by selecting available ports from the start point to the end point while searching the database of the EMS. Therefore, when the number of the transmission apparatuses increases, the search process increases, so that the process time increases. In addition, when the repeated process occurs, the process time further increases.

The present invention is contrived in view of the above-mentioned problem, and the object is to decrease the path route search process time.

### Means for Solving the Problem

The object can be achieved by a path route calculation apparatus for obtaining a route of ports of a path in a communication network configured by connecting a plurality of transmission apparatuses by links with each other, the path route calculation apparatus including:

a condition receiving unit configured to receive a condition including identification information of transmission apparatuses existing on the path and a signal level of the path;

a table generation unit configured to generate a table, for each of transmission apparatuses on the path, that includes identifiers of each port corresponding to the signal level and flags indicating use status of each port;

a path route determination unit configured to determine the route of ports of the path by performing logical operation for values of the flags in tables generated by the table generation unit.

### EFFECT OF THE INVENTION

According to the present invention, tables including flags indicating use status of ports are generated in the path route calculation apparatus, and the route of ports of the path is calculated by logical operation on the tables. Thus, path route search process time can be decreased.

### BRIEF DESCRIPTION OF THE DRAWINGS

FIGS. 1A and 1B are diagrams showing a configuration of a system including transmission apparatuses, NMSes and EMSes;

FIG. 2 is a diagram showing an example of an apparatus layout of one shelf of a transmission apparatus;

FIG. 3 is a diagram showing signal levels that can be included and assigning rules for assignment identifiers for each unit type;

FIG. 4 is a diagram showing assignment identifiers for each signal level when a unit of STM16S is implemented into a slot 19;

FIG. 5 is a network configuration diagram used for explaining path route search processes;

FIG. 6 is a flowchart showing a conventional path route search process;

FIG. 7 is a diagram showing a conventional path route search process;

FIG. 8 is a diagram for explaining a case for performing route search for a path that is a target of BLSR;

FIG. 9 is a diagram for explaining a case for performing route search for a path that is not a target of BLSR;

FIG. 10 is a diagram showing a hardware configuration example of the NMS of an embodiment of the present invention;

FIG. 11 is a diagram showing a functional configuration of the NMS of an embodiment of the present invention;

FIG. 12 is a flowchart of a path route search process in an embodiment of the present invention;

FIG. 13 is a diagram showing a table corresponding to an output side of the transmission apparatus 1;

FIG. 14 is a diagram showing tables of transmission apparatuses 1-3;

FIG. 15 is a diagram for explaining a path route search process when a search object path is a target of BLSR;

FIGS. 16A and 16B are diagrams for explaining a path route search process when a search object path is not a target of BLSR;

FIG. 17 is a diagram showing a table that is updated after the path is determined;

FIG. 18 is a diagram showing information before updating in the EMS;

FIG. 19 is a diagram showing information after update in the EMS;

FIG. 20 is a diagram showing search process time in relation to path numbers to be searched in the present embodiment and the conventional method.

### DESCRIPTION OF REFERENCE SIGNS

1-4 transmission apparatus
10 memory
11 CPU
12 storage apparatus
13 input apparatus
14 output apparatus
15 communication apparatus
21 condition receiving unit
22 table generation unit
23 path route determination unit

### PREFERRED EMBODIMENTS FOR CARRYING OUT THE INVENTION

In the following, embodiments of the present invention are described with reference to figures.

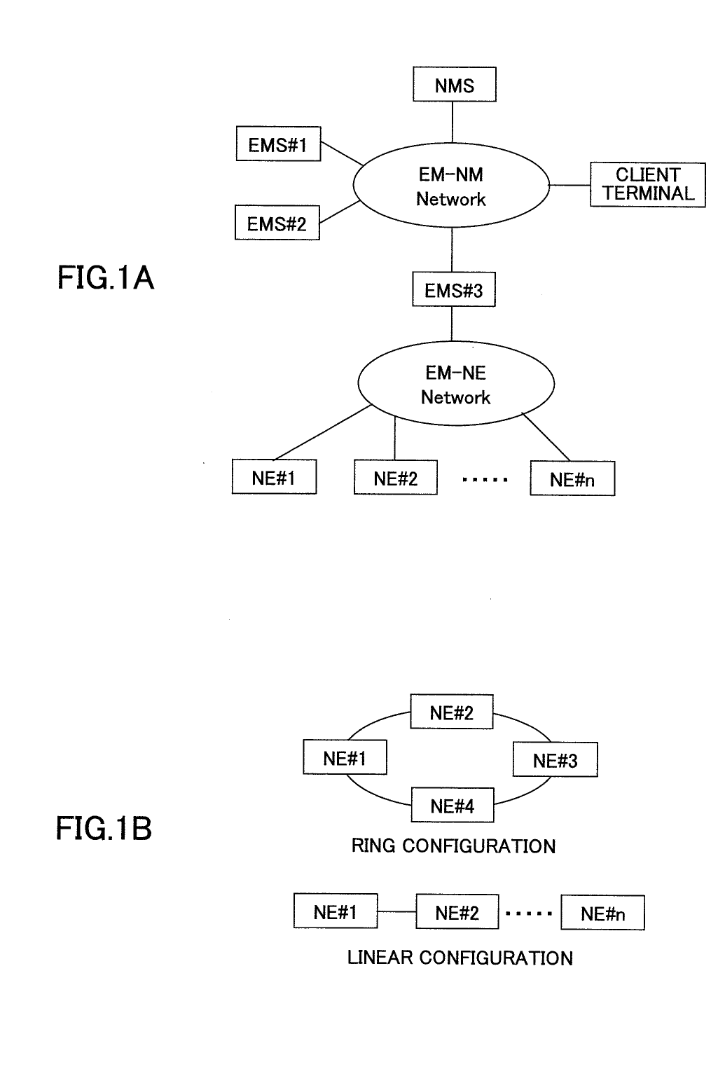

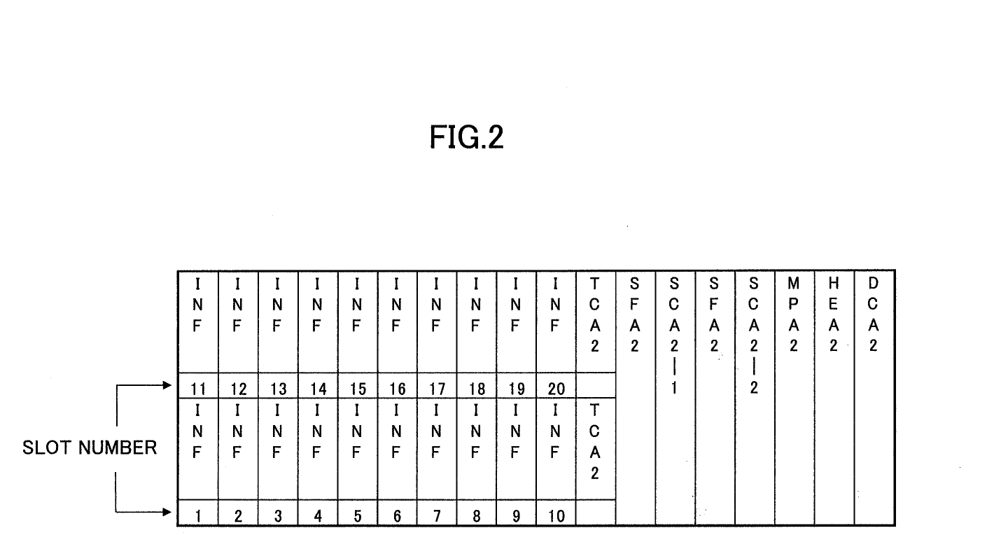

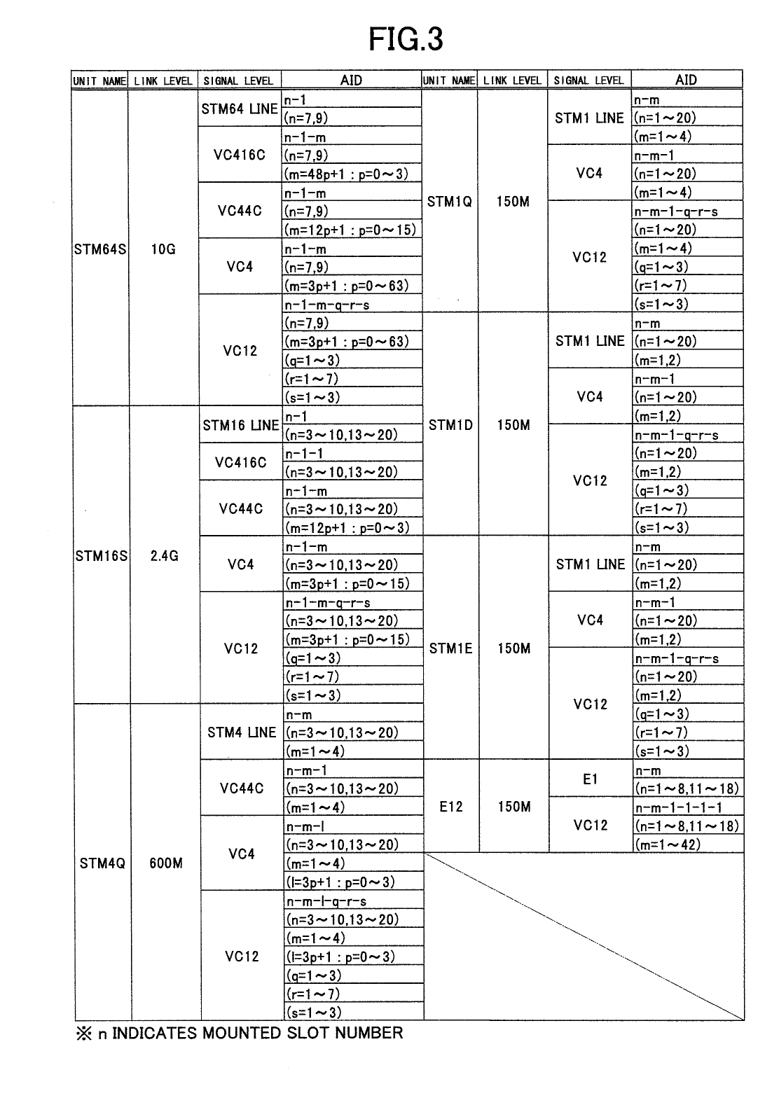

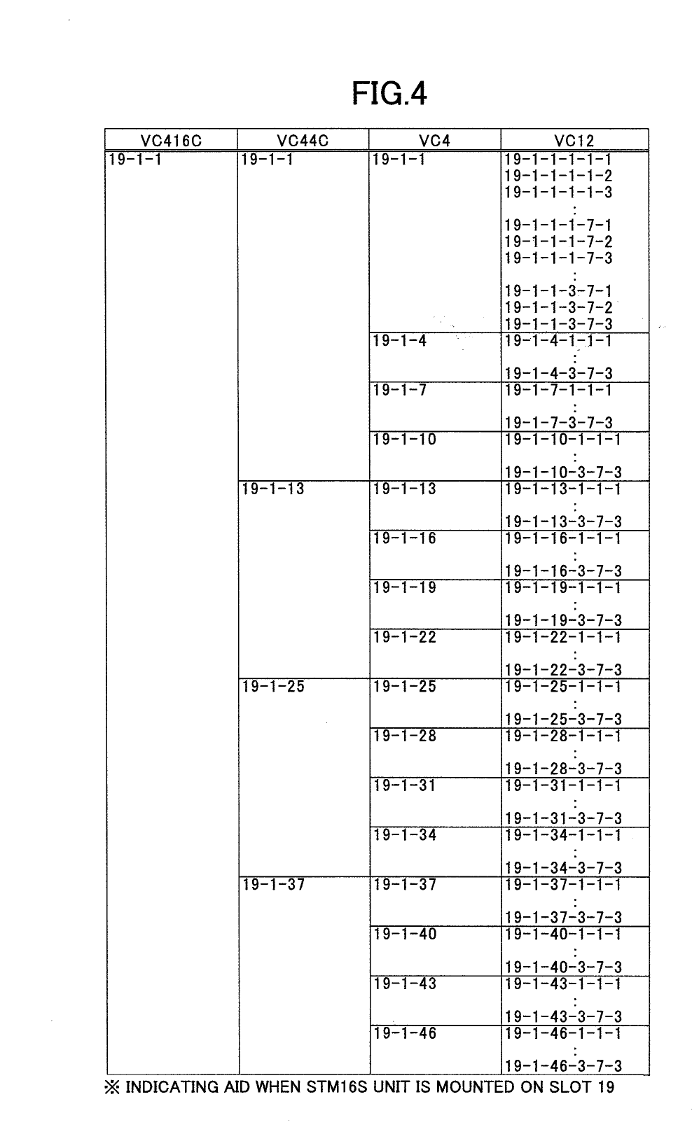

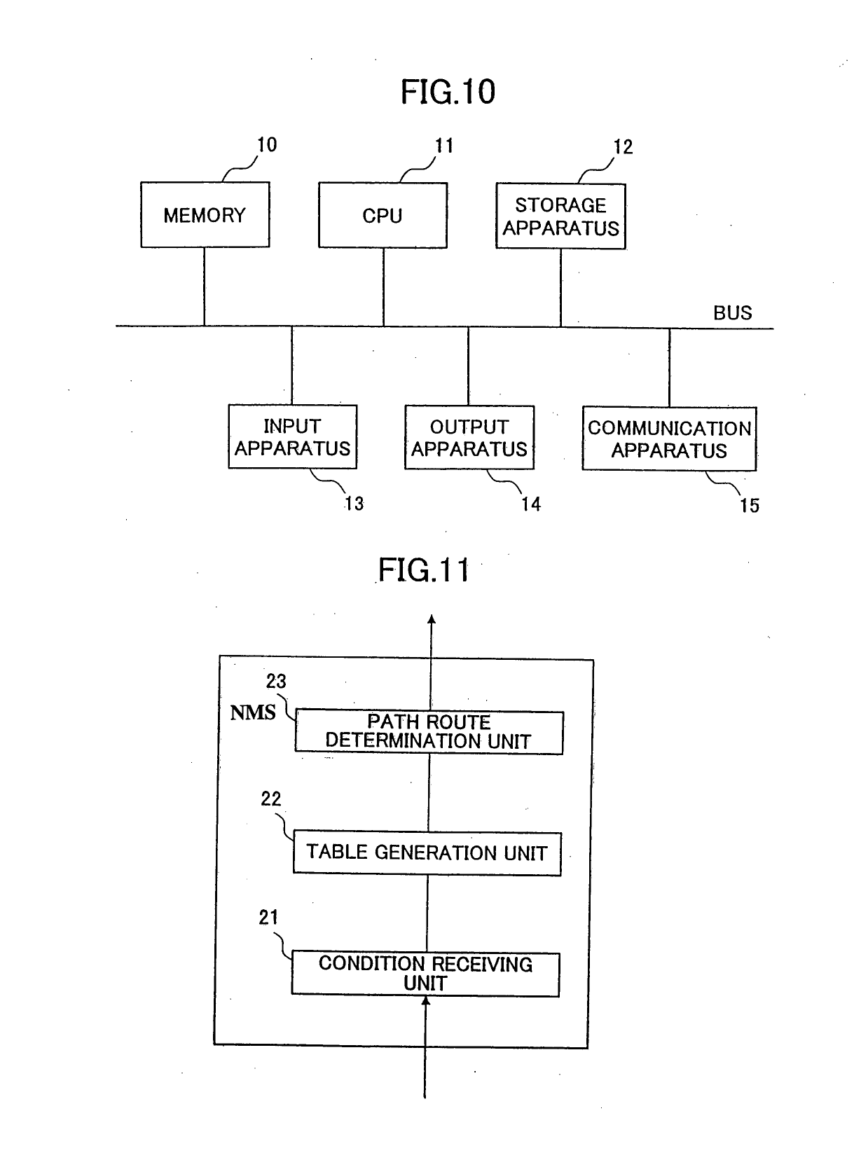

The NMS that is an embodiment of the path route calculation apparatus of the present invention is used in the system configuration shown in FIG. 1. In addition, this NMS is realized by installing a program, into a general computer, for executing processes in this embodiment. FIG. 10 shows a hardware configuration example of the NMS of the present embodiment. As shown in FIG. 10, the NMS of the present embodiment includes at least a memory 10, a CPU 11, a storage apparatus 12 (hard disk and the like), an input apparatus 13, an output apparatus 14, and a communication apparatus 15 for connecting a network.

In addition, FIG. 11 shows a functional configuration of the NMS of the present embodiment. As shown in FIG. 11, the NMS includes at least a condition receiving unit 21, a table generation unit 22 and a path route determination unit 23. The condition receiving unit 21 has a function for receiving conditions including identification information of transmission apparatuses on a path and a signal level of the path and the like. The table generation unit 22 has a function for generating a table, for each transmission apparatus on the path, including identifiers of each port corresponding to the signal level and flags indicating using status of each port. In addition, the path route determination unit 23 has a function for determining a route of ports of the path by performing logical operation for values of flags in the table generated by the table generation unit 22. These functional units are realized by executing a program on a computer used as the NMS. By the way, the program can be installed into the computer from a recording medium such as a flexible disk, a CD-ROM, a card memory and the like via the input apparatus. In addition, the program can be also downloaded from a server on a network via a communication apparatus 15.

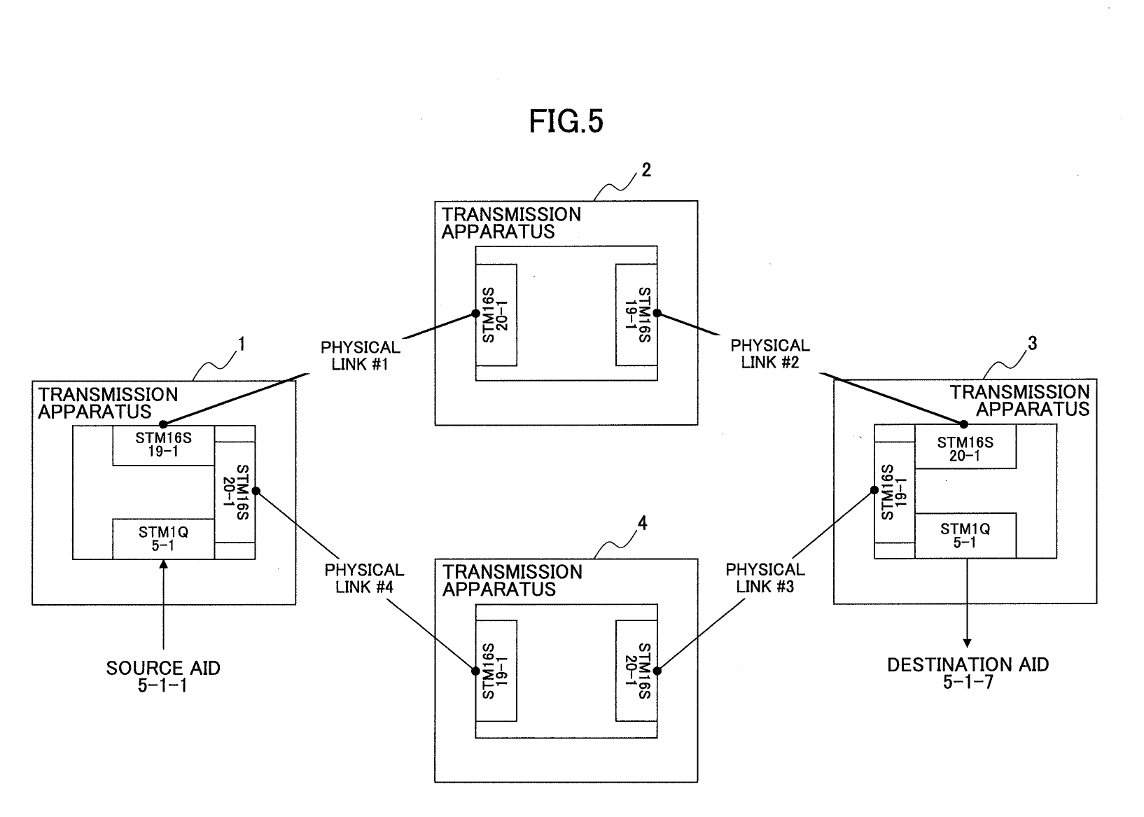

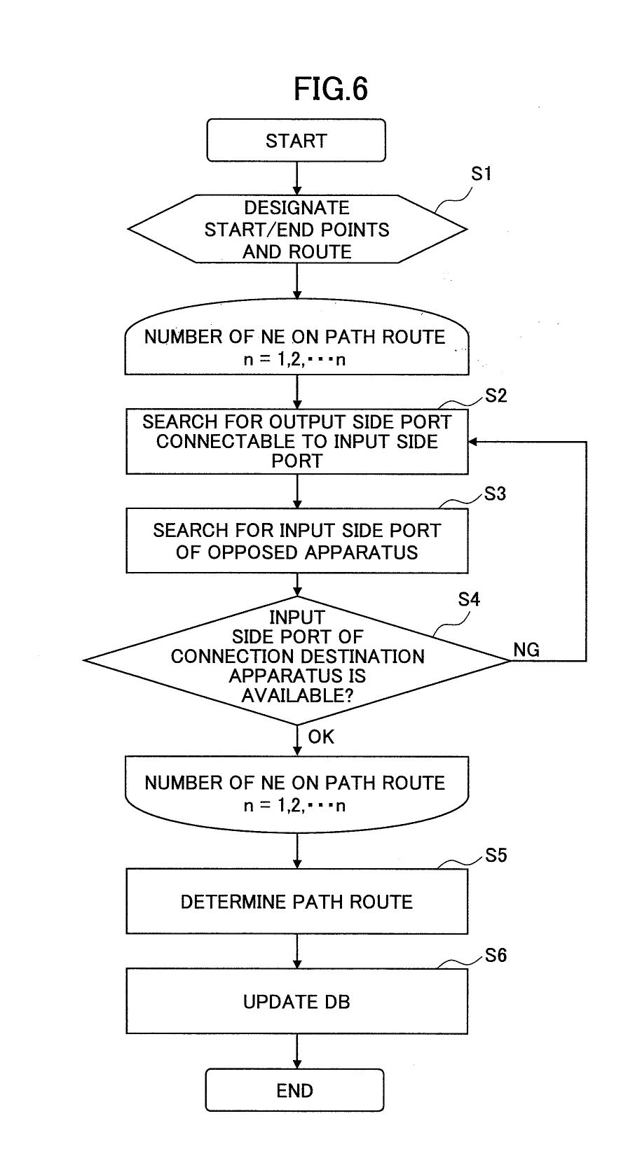

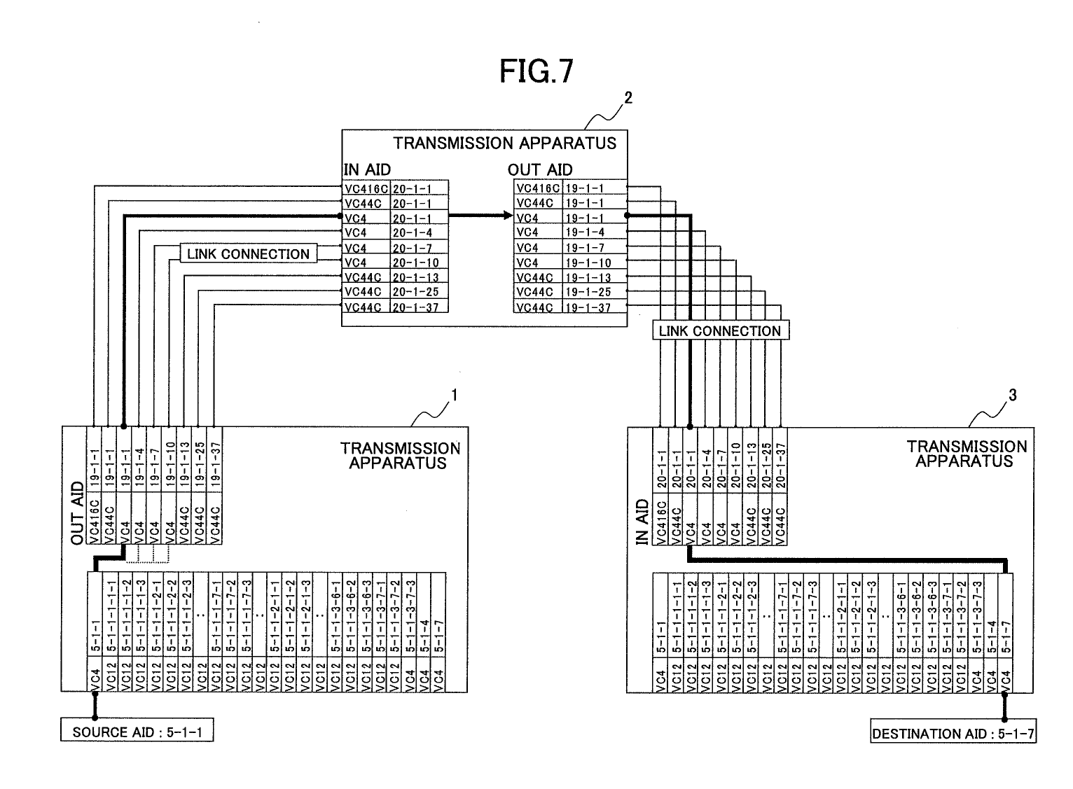

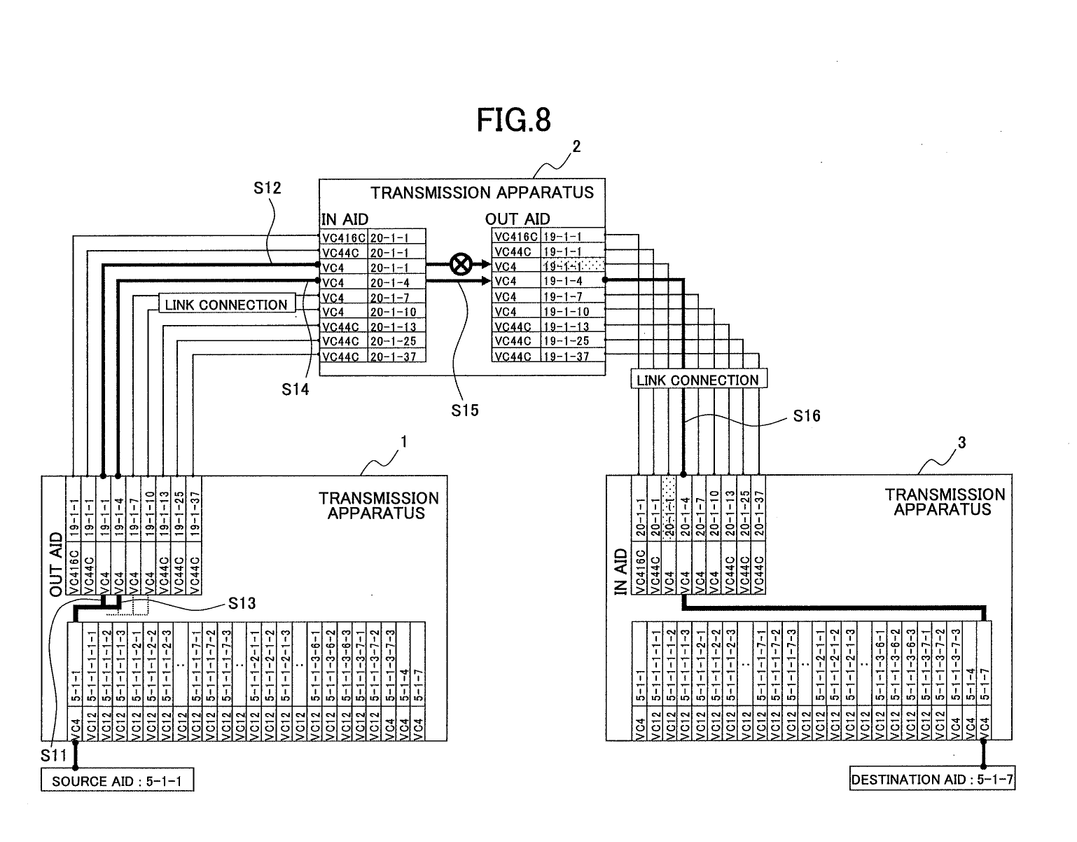

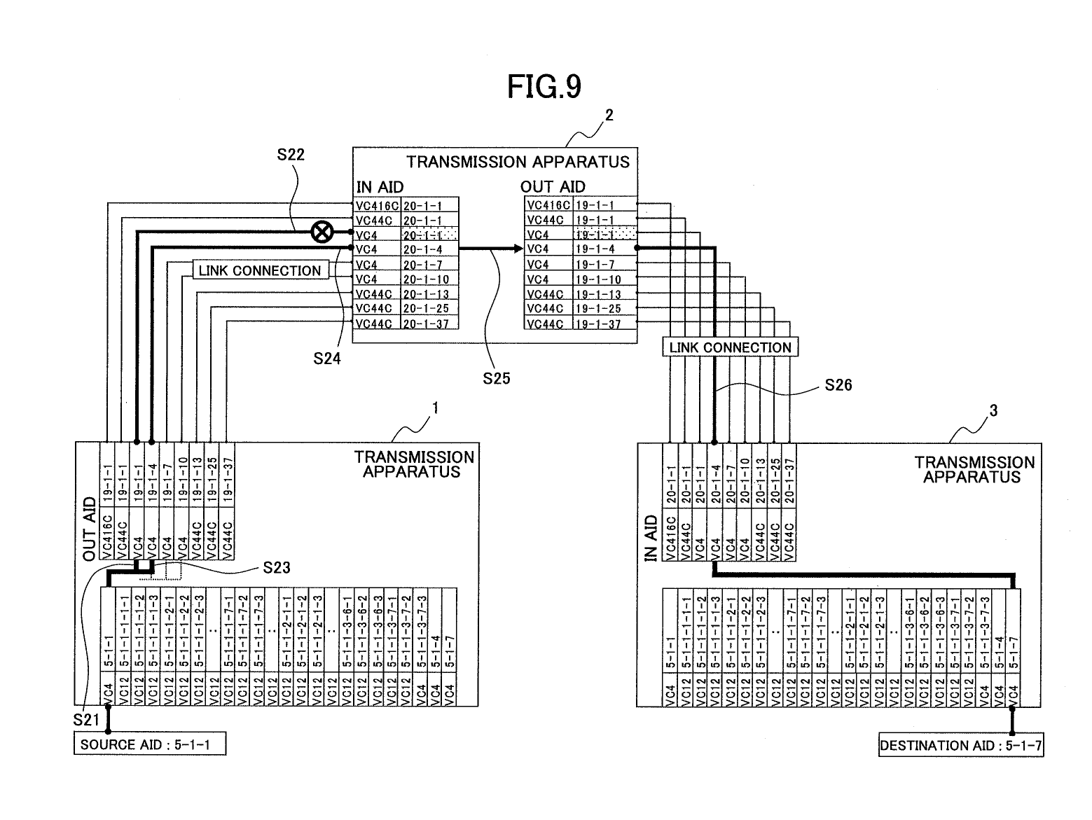

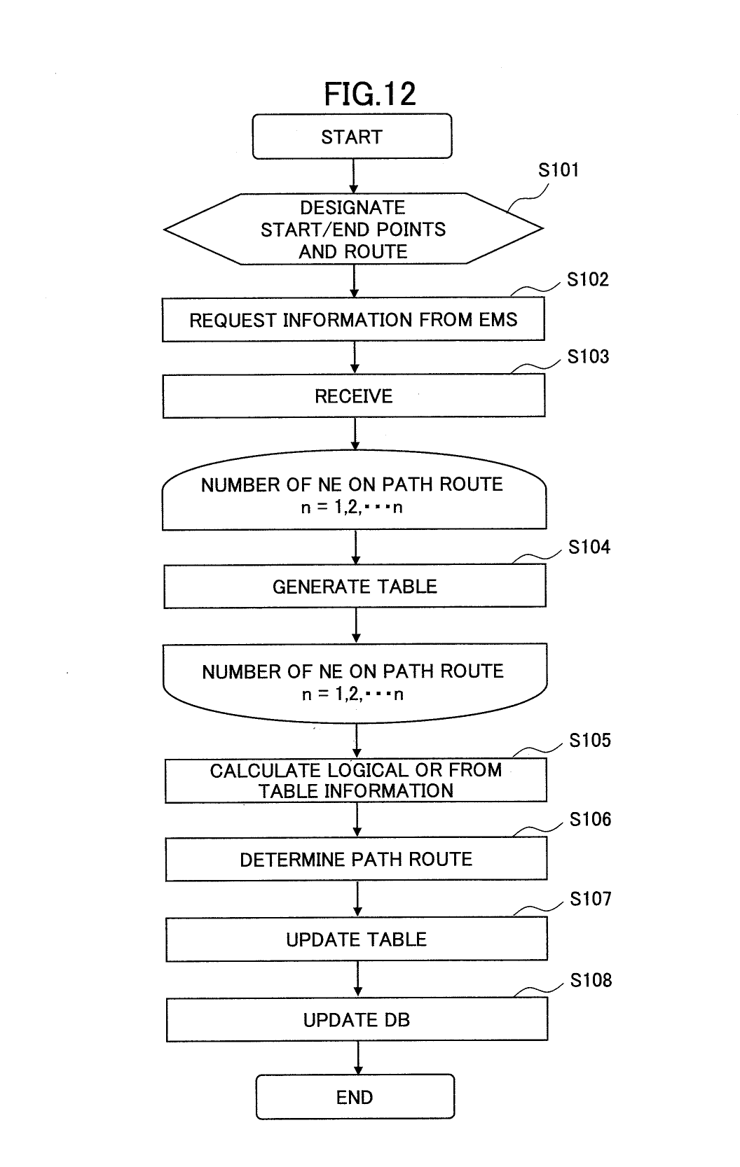

In the following, processes executed by the NMS including such configuration and functions are described along with steps show in a flowchart of FIG. 12. The process described below is based on the network configuration shown in FIG. 5, and it is assumed that condition designation the same as that of FIG. 7 is performed. But, in this example, it is assumed that output side ports: 19-1-1 and 19-1-4 of the transmission apparatus 2 and input side ports: 20-1-1 and 20-1-4 of the transmission apparatus 3 are in use.

First, in step 101, an operator enters path search conditions using a client terminal. The path search conditions are start point: 5-1-1, end point: 5-1-7, route: transmission apparatus 1->transmission apparatus 2->transmission apparatus 3, and a signal level: VC4.

The NMS that receives the search conditions requests port assignment information by passing the conditions to the EMS that manages transmission apparatuses on the route in step 102.

The NMS that receives the request searches for units that are physically connected between transmission apparatuses. In the present embodiment, as shown in FIG. 5, between the transmission apparatus 1 and the transmission apparatus 2, a unit of assignment identifier: 19-1 of the transmission apparatus 1 is selected, and a unit of assignment identifier: 20-1 of the transmission apparatus 2 is selected. Between the transmission apparatus 2 and the transmission apparatus 3, a unit of assignment identifier: 19-1 of the transmission apparatus 2 is selected, and a unit of assignment identifier: 20-1 of the transmission apparatus 3 is selected.

For each port of each signal level for each unit, the EMS holds information indicating whether the port is in use (or reserved). After the above-mentioned unit selection, the EMS obtains assignment identifiers of ports corresponding to VC4 that is the search condition and in-use/not in-use information corresponding to those.

Then, the EMS sends the obtained port assignment identifiers and in-use/not in-use information corresponding to these to the NMS as a response of the request. In step 103 of FIG. 12, the NMS receives the information.

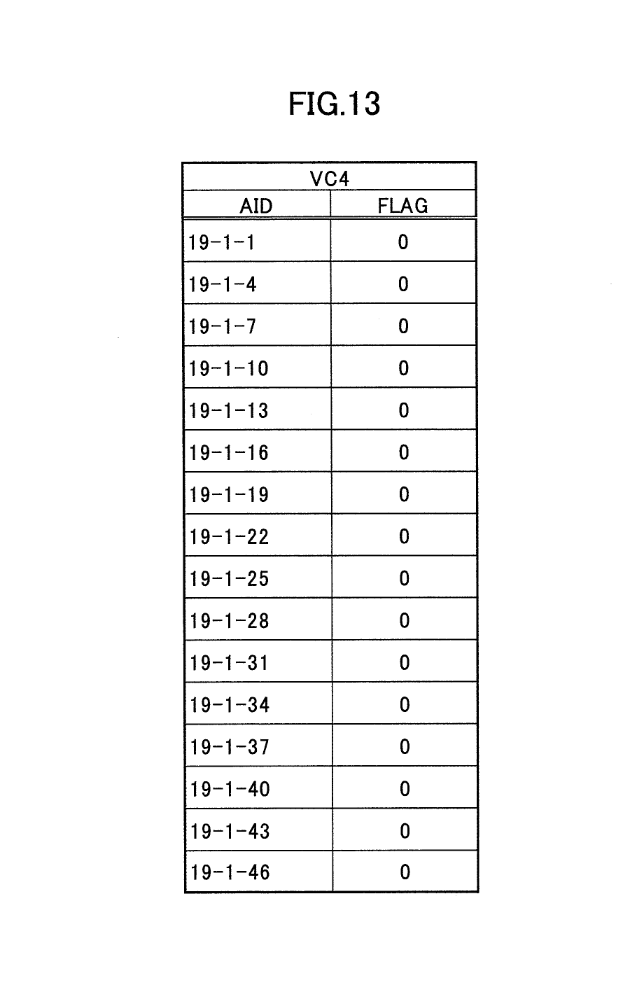

In step 104, the NMS that receives the information generates a table in which in-use/not in-use flags (FLAG) are added to assignment identifiers (AIDs) based on the received in-use/not in-use information for each of the output side and the input side of each transmission apparatus, and stores the generated tables in the memory 10. For example, as to the output side of the transmission apparatus 1, a table shown in FIG. 13 is generated. As to FLAG, “0” indicates not in-use, and “1” indicates in-use.

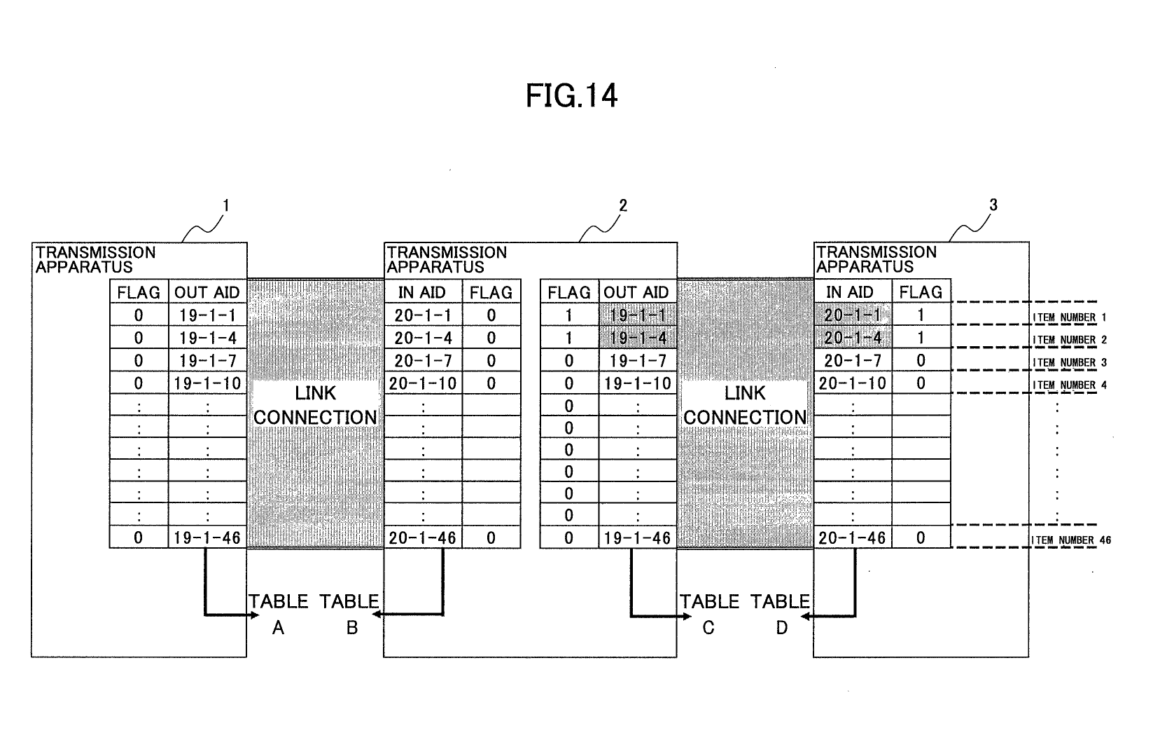

FIG. 14 is a diagram showing tables of transmission apparatuses 1-3. As shown in FIG. 14, a unit: 19-1 of the transmission apparatus 1 and a unit: 20-1 of the transmission apparatus 2 are physically connected, and a unit: 19-1 of the transmission apparatus 2 and a unit: 20-1 of the transmission apparatus 3 are physically connected. In addition, the table A is a table of the output side of the transmission apparatus 1, the table B is a table of the input side of the transmission apparatus 2, the table C is a table of the output side of the transmission apparatus 2, and the table D is a table of the input side of the transmission apparatus 3. Further, in FIG. 14, corresponding ports of transmission apparatuses 1-3 are identified using “item number”. By the way, since the assignment identifiers are determined based on the assigning rule that is used for all transmission apparatuses in common, the last numbers of assignment identifiers of the same order in each table are the same.

After generating the table shown in FIG. 14, the NMS determines a route by calculating logical OR for a plurality of tables in steps 105 and 106 in FIG. 12. This process is described using two examples where one example is a case in which a search object path is a target of BLSR and another example is a case in which the search object path is not a target of BLSR.

(In the Case of BLSR)

As mentioned before, when the search object path is a target of BLSR, it is necessary that the last numbers of port assignment identifiers are the same through the path route. Therefore, the NMS calculates logical OR for corresponding ports for all of the tables A-D of the transmission apparatuses 1-3. By the way, in the case shown in FIG. 14, “corresponding ports” are ports whose order from the top of the tables are the same.

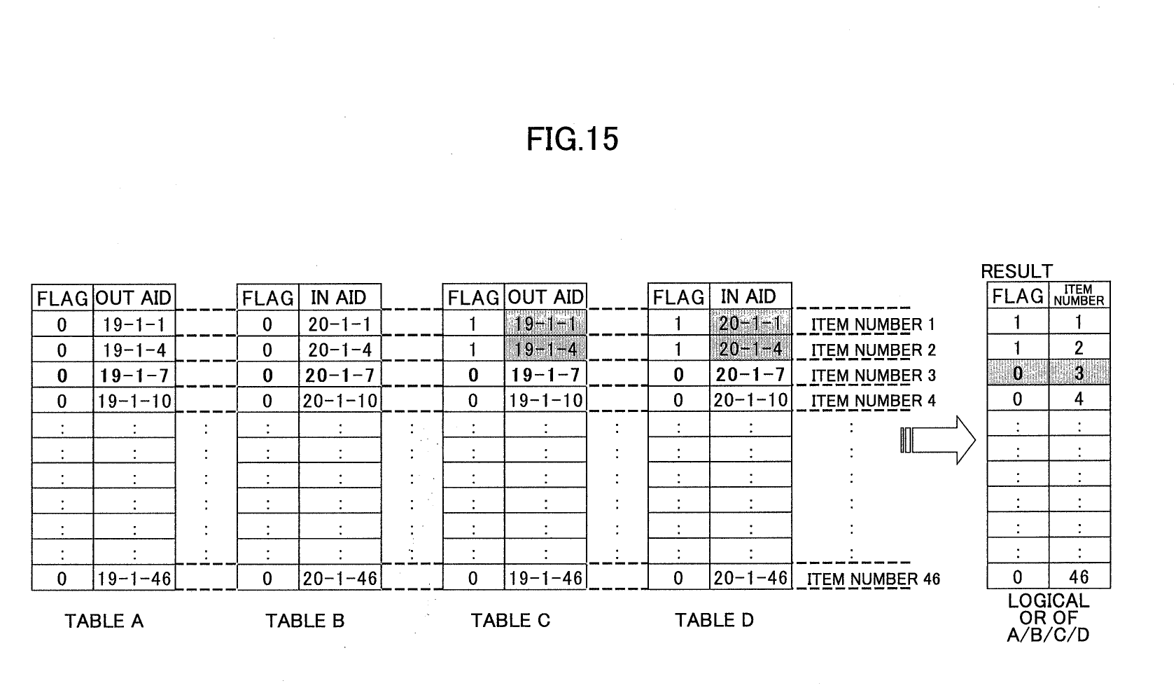

As shown in FIG. 15, FLAG of the output side port: 19-1-1 of the transmission apparatus 1 is 0, FLAG of the input side port: 20-1-1 of the transmission apparatus 2 is 0, FLAG of the output side port: 19-1-1 of the transmission apparatus 2 is 1, and FLAG of the input side port: 20-1-1 of the transmission apparatus 3 is 1. Therefore, since 0 OR 0 OR 1 OR 1=1 holds true, the result of the item number 1 is 1.

In the same way, the result of the item number 2 is 1, and the result of the item number 3 is 0. The fact that an result of an item number is 1 indicates that at least one port is in use among ports in the transmission apparatuses 1-3 corresponding to the item number. Therefore, the ports of the item number 1 are not adopted. The fact that an result of an item number is 0 indicates that every port in the transmission apparatuses 1-3 corresponding to the item number is not in-use. Therefore, one of item numbers whose result is 0 is selected. In the example of FIG. 15, the item number 3 is selected. Therefore, a route of ports of a path indicated by 5-1-1->19-1-7->20-1-7->19-1 -7->20-1-7->5-1-1-7 is selected.

(In the Case of not BLSR)

When the search object path is not a target of BLSR, it is not necessary that the last numbers of assignment identifiers of ports are the same through the path route. Therefore, in this case, the NMS determines a path route by calculating logical OR for each pair of two transmission apparatuses connected by a physical link. More particularly, logical OR operation is performed as described below.

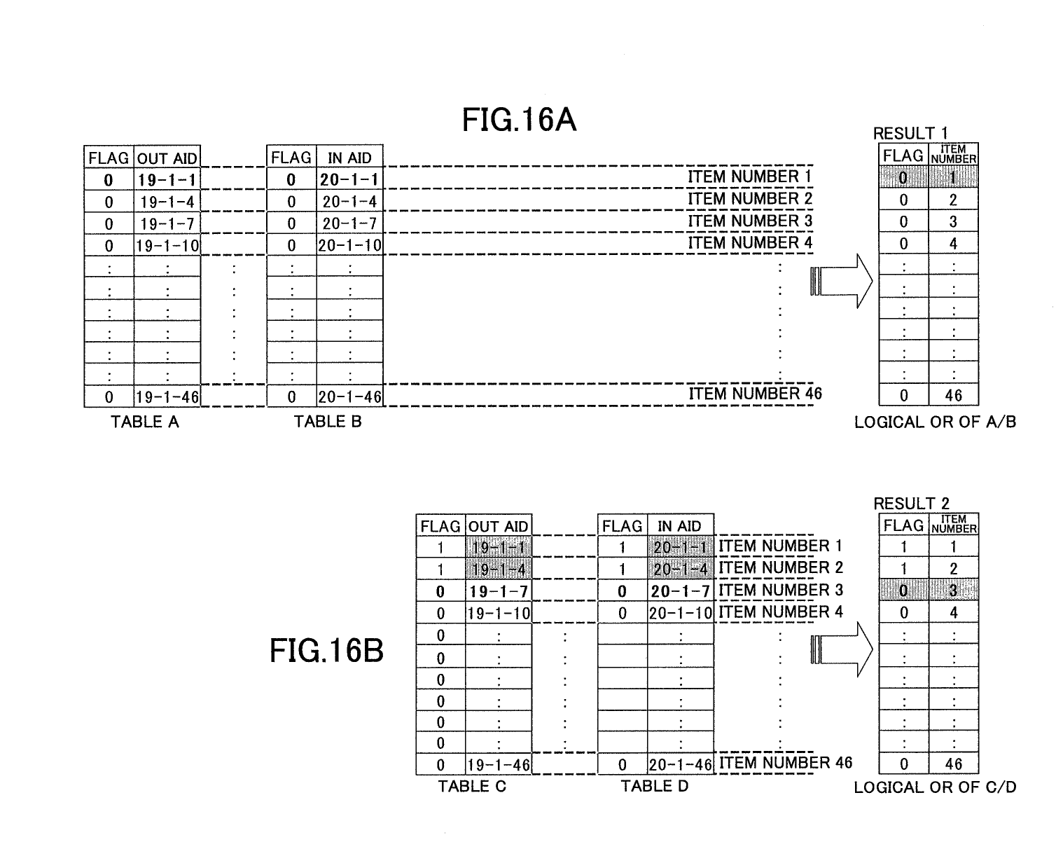

As shown in FIGS. 16A and 16B, the NMS calculates logical OR from the table A of the transmission apparatus 1 and the table B of the transmission apparatus 2 to obtain a result 1, and calculates logical OR from the table C of the transmission apparatus 2 and the table D of the transmission apparatus 3 to obtain a result 2. Then, the NMS selects an item number 1 from item numbers in which FLAG is 0 in the result 1, and selects an item number 3 from item numbers in which FLAG is 0 in the result 2. Accordingly, a path route of 5-1-1 ->19-1-1->20-1-1->19-1-7->20-1-7->5-1-1-7 is determined.

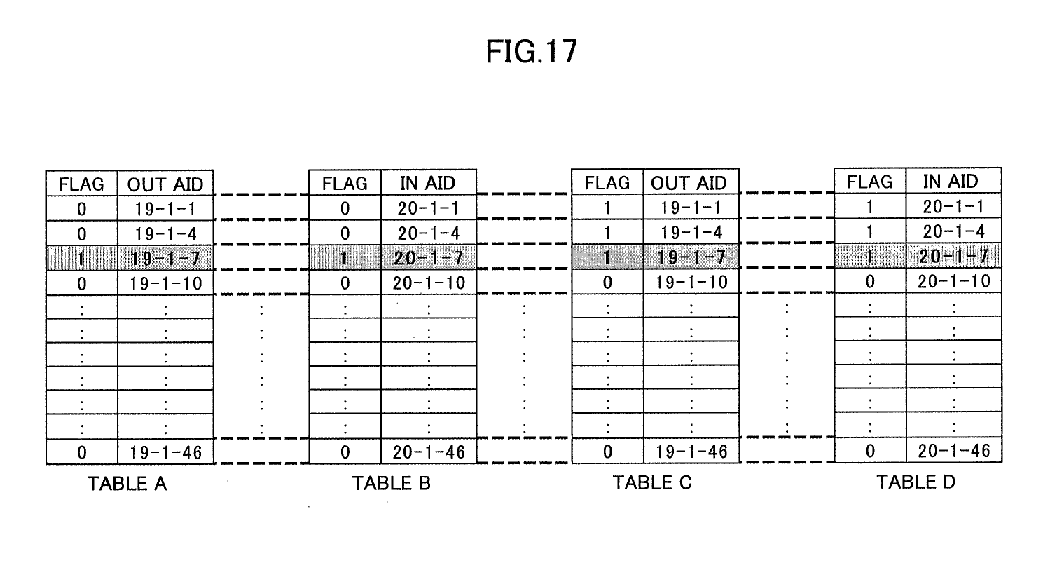

Next, update of the tables are performed in step 107 in FIG. 12. For example, as to the example shown in FIG. 15, the NMS updates in-use/not in-use information of VC4 ports in the STM16S units in each transmission apparatus as shown in FIG. 17. When path route search is performed next, the updated table will be used.

Next, in step 108 in FIG. 12, the NMS sends information of the path determined by the path route search process to the EMS to request database update in the EMS.

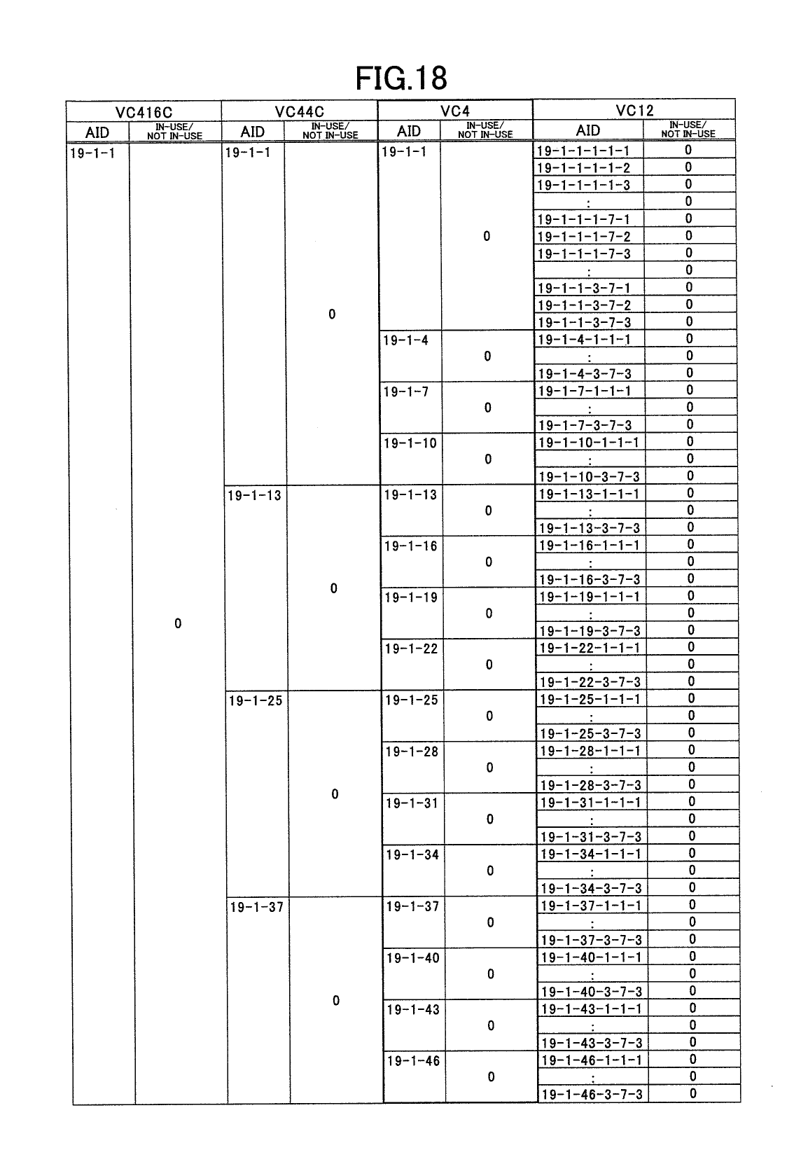

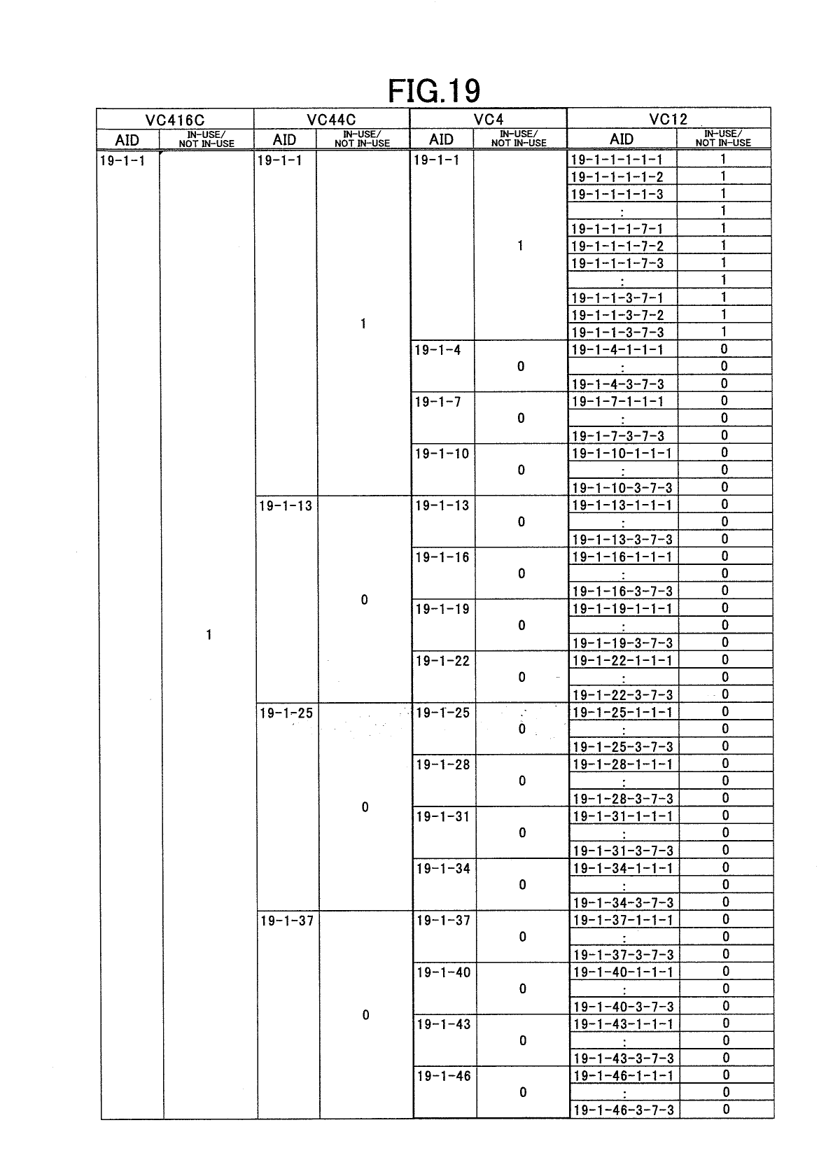

The EMS that receives the path information updates in-use/not in-use information corresponding to assignment identifiers of the selected ports. When a particular port in a particular signal level is used, signal levels higher and lower than the port become unavailable. Thus, the EMS further updates port information of higher/lower of the port. For example, assuming that information corresponding to a STM16S unit: 19-1 of the transmission apparatus 1 is as shown in FIG. 18 before updating, the information is updated as shown in FIG. 19.

As described above, according to the path search process method described in the present embodiment, since tables are generated in the NMS in an initial stage of search process, it becomes unnecessary to perform database search for the EMS in the path search process.

In addition, according to the method of the present embodiment, a path route can be determined only by the logical operation between tables. Therefore, the repeated process that was performed in the conventional method can be eliminated, so that the path search process time can be decreased. For example, in the configuration shown in FIG. 5, there is a possibility that repeated search occurs 16 times for example according to the conventional method when registering 16 VC4s. On the other hand, according to the method of the present embodiment, repeated search does not occur. In addition, there is a possibility that repeated process occurs 1008 times when registering 1008 VC12s. On the other hand, repeated search does not occur according to the method of the present embodiment.

In addition, according to the method of the present embodiment, since database search for each transmission apparatus is not performed, increase of the number of transmission apparatuses on a path has little effect on path search process time.

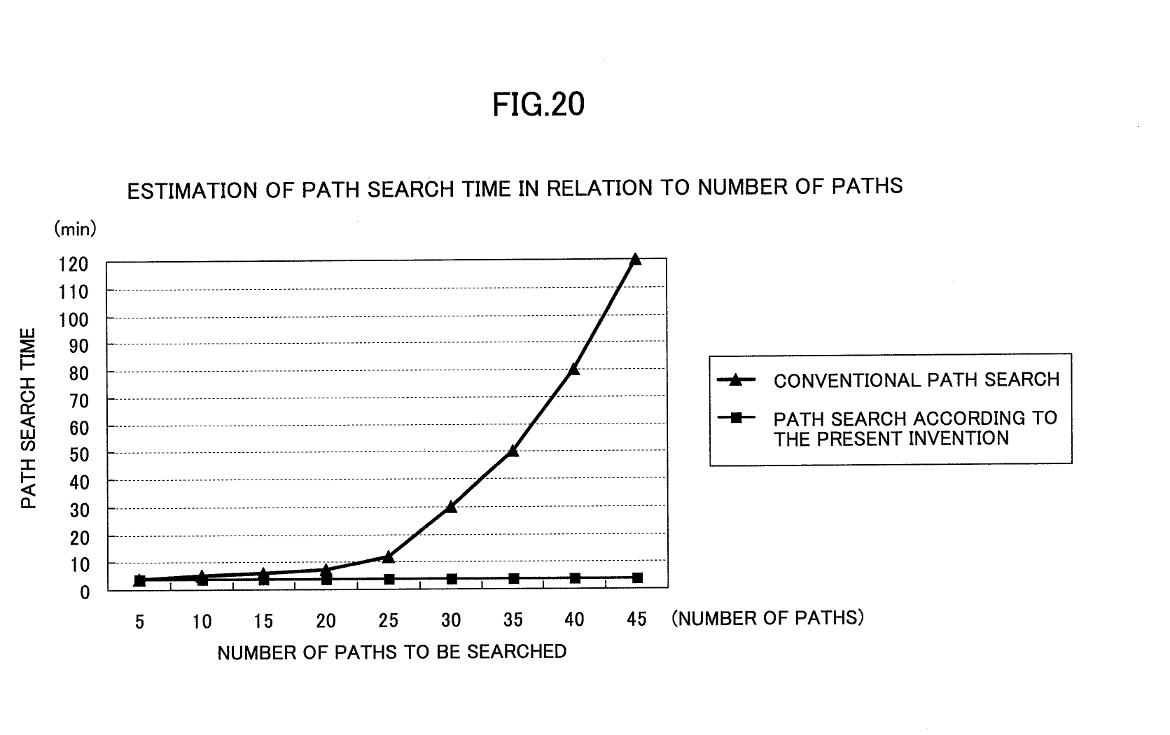

From the above-mentioned point, path search process time of the present embodiment is shorter than path search time in the conventional method. FIG. 20 shows search process time in relation to path numbers to be searched in the present embodiment and the conventional method. By the way, the search process time of the present embodiment in FIG. 20 is an estimated value. As shown in FIG. 20, process time increases as the number of paths to be searched increases according to the conventional method. The cause of this is that repeated search process occurrence increases due to increase of ports in use by path search. On the other hand, according to the method of the present embodiment, the search time barely increases even though the number of paths increases.

As described above, according to the method of the present embodiment, the number of already registered paths and transmission apparatuses on the route has little effect on the path search process time, so that speeding up of the process and stabilization of the process can be realized.

The present invention is not limited to the specifically disclosed embodiments, and variations and modifications may be made without departing from the scope of the invention.

1. A path route calculation apparatus for obtaining a route of ports of a path in a communication network configured by connecting a plurality of transmission apparatuses by links with each other, the path route calculation apparatus comprising:
a condition receiving unit configured to receive a condition including identification information of transmission apparatuses existing on the path and a signal level of the path;
a table generation unit configured to generate a table, for each of transmission apparatuses on the path, that includes identifiers of each port corresponding to the signal level and flags indicating use status of each port;
a path route determination unit configured to determine the route of ports of the path by performing logical operation for values of the flags in tables generated by the table generation unit.

2. The path route calculation apparatus as claimed in claim 1, wherein the path route determination unit performs the logical operation for each pair of two tables of transmission apparatuses connected to each other by a-link to determine the route of ports of the path from the operation result for each pair of the two tables.

3. The path route calculation apparatus as claimed in claim 1, wherein the path route determination unit performs the logical operation for tables of all transmission apparatuses on the path to determine the route of ports of the path from the operation result.

4. The path route calculation apparatus as claimed in claim 1, wherein the value of the flag is a value indicating that a port is in use or that the port is not in use, the logical operation is operation for obtaining logical OR of values of flags for each set of corresponding ports among the tables, and the path route determination unit determines the route of the ports of the path by selecting a set of ports where the operation result of the logical operation indicates that ports are not in use.

5. The path route calculation apparatus as claimed in claim 1, wherein the path route calculation apparatus obtains identifiers of each port corresponding to the signal level and information of use status of each port of the transmission apparatuses on the path from a transmission apparatus management apparatus that holds path setting information of the plurality of transmission apparatuses in response to receiving the condition.

6. A path route calculation method performed in a path route calculation apparatus for obtaining a route of ports of a path in a communication network configured by connecting a plurality of transmission apparatuses by links with each other, comprising:
a condition receiving step of receiving a condition including identification information of transmission apparatuses existing on the path and a signal level of the path;
a table generation step of generating a table, for each of transmission apparatuses on the path, that includes identifiers of each port corresponding to the signal level and flags indicating use status of each port;
a path route determination step of determining the route of ports of the path by performing logical operation for values of the flags in tables generated in the table generation step.

7. The path route search calculation method as claimed in claim 6, wherein, in the path route determination step, the path route calculation apparatus performs the logical operation for each pair of two tables of transmission apparatuses connected to each other by a link to determine the route of ports of the path from the operation result for each pair of the two tables.

8. The path route calculation method as claimed in claim 6, wherein the path route determination step, the path route calculation apparatus performs the logical operation for tables of all transmission apparatuses on the path to determine the route of ports of the path from the operation result.

9. The path route calculation method as claimed in claim 6, wherein the value of the flag is a value indicating that a port is in use or that the port is not in use, the logical operation is operation for obtaining logical OR of values of flags for each set of corresponding ports among the tables, and the path route calculation apparatus determines, in the path route determination step, the route of the ports of the path by selecting a set of ports where the operation result of the logical operation indicates that ports are not in use.

10. The path route calculation method as claimed in claim 6, wherein the path route calculation apparatus obtains identifiers of each port corresponding to the signal level and information of use status of each port of the transmission apparatuses on the path from a transmission apparatus management apparatus that holds path setting information of the plurality of transmission apparatuses in response to receiving the condition.

11. A program for causing a computer to function as a path route calculation apparatus for obtaining a route of ports of a path in a communication network configured by connecting a plurality of transmission apparatuses by links with each other, the program causing the computer to function as:
a condition receiving unit configured to receive a condition including identification information of transmission apparatuses existing on the path and a signal level of the path;
a table generation unit configured to generate a table, for each of transmission apparatuses on the path, that includes identifiers of each port corresponding to the signal level and flags indicating use status of each port;
a path route determination unit configured to determine the route of ports of the path by performing logical operation for values of the flags in tables generated by the table generation unit.

12. A computer readable recording medium storing the program as claimed in claim 11.
